(19) United States
(12) Patent Application Publication
(10) Pub. No.: US 2008/0184245 A1
(43) Pub. Date: Jul. 31, 2008

(54) METHOD AND SYSTEM FOR TASK-BASED VIDEO ANALYTICS PROCESSING

(75) Inventor: Richard ST-JEAN, Kanata (CA)

Correspondence Address: BORDEN LADNER GERVAIS LLP;Anne Kinsman, WORLD EXCHANGE PLAZA, 100 QUEEN STREET SUITE 1100, OTTAWA, ON, K1P 1J9, omitted

(73) Assignee: MARCH NETWORKS CORPORATION, Ottawa (CA)

(21) Appl. No.: 12/022,517

(22) Filed: Jan. 30, 2008

Related U.S. Application Data
(60) Provisional application No. 60/887,198, filed on Jan. 30, 2007.

(51) Int. Cl. G06F 9/50

(52) U.S. Cl. 718/103; 718/104

(57) ABSTRACT

A task-based video analytics system and method are provided, which can include dynamic allocation and sharing of video analytics resources. Video analytics tasks are created in response to trigger information, which can be based on stored business rules, events and/or data of interest. The tasks are forwarded to a video analytics task manager, which manages and distributes tasks to appropriate video analytics resources according to parameters such as scheduling, priority and/or events. Video from the appropriate video source, either a video stream or stored video, is only obtained after the video analytics task is received at the video analytics resource. Video analytics are performed on the video itself, not on video metadata. Data mining of non-video metadata can be used to identify stored video of interest. Configuration tuning can be used to modify a business rule and validate whether the modified rule would affect previous correct data.

### CROSS-REFERENCE TO RELATED APPLICATIONS

This application claims the benefit of priority of U.S. Provisional Patent Application No. 60/887,198 filed on Jan. 30, 2007, which is incorporated herein by reference in its entirety.

### FIELD OF THE INVENTION

The present invention relates generally to video processing. More particularly, the present invention relates to video analytics processing.

### BACKGROUND OF THE INVENTION

In the realm of digital video processing, different video capabilities and levels of processing complexity are assigned and fixed to different cameras. For example, a first camera is dedicated to motion detection, a second camera is dedicated to trip wire processing, and a third camera is dedicated to detection of loitering. Using the example of the third camera, typically an end user purchases a specific license for loitering detection for that camera (including detecting people and analyzing their behaviour in relation to timers). If such a camera is installed at a bank's automated teller machine (ATM), the camera cost and license cost is wasted during times when no one is present in the vicinity of the ATM. Dedicated processing can therefore be restrictive.

Licenses for video analytics are typically granted for a particular device and for a particular function. The cost for analytics, in terms of licensing fees and resource utilization, is proportional to the complexity of the analytics algorithm. A significant investment in specific hardware and licenses for each piece of hardware can be involved, without offering much flexibility.

In some approaches, a video processing system can use shared resources to process video from a number of camera sources. For example, United States Patent Application Publication No. 2007/0013776 published on Jan. 18, 2007 to Venetianer et al. describes a video surveillance system employing video primitives. Video streams are brought in frame by frame, then primitives (or metadata) are created based on the video stream, and the primitives are sent out to post-processing departments. Most of the video processing and content analysis is done at the cameras, and a small proportion of the processing, which is post-primitive processing, is distributed to the post-processing departments. According to this approach, processing must be performed in real-time, and the video content analysis does not include inference processing.

In another example, United States Patent Application Publication No. 2005/0232462 published on Oct. 20, 2005 to Vallone et al. describes a pipeline architecture for analyzing multiple video streams. A video stream enters the pipeline and the system performs quick processing, then deep processing, then cluster processing, and finally database processing. If processing in an upper stage is desired, a video stream must go through each preceding stage. Certain video stream information can be filtered out of the video stream after each stage, and higher stages often process based on video metadata, rather than the video itself. According to this approach, each stage must be performed in real-time. Each time higher level processing resources are used, each of the lower level processing resources is necessarily used and no stage can be skipped.

While video analytics is now used for real-time applications such as safety and security, there are some situations in which non-real-time video analytics are desired. The term “video analytics” as used herein represents any technology used to analyze video for specific data, behavior, objects or attitude. Typically, video analytics includes both video content analysis and inference processing. Some examples of video analytics applications include: counting the number of pedestrians entering a door or geographic region; determining the location, speed and direction of travel; identifying suspicious movement of people or assets; license plate identification; and evaluating how long a package has been left in an area. Known approaches do not provide sufficient adaptability to increasing user demand for non-real-time video analytics using shared resources.

Therefore, it is desirable to provide a system and method whereby video analytics can be performed in a flexible and resource efficient manner.

### SUMMARY OF THE INVENTION

It is an object of the present invention to obviate or mitigate at least one disadvantage of previous video analytics approaches.

A task-based approach makes more efficient use of video analytics resources by only using the resources when necessary, and by providing a mechanism to manage tasks from a number of different requesting devices.

In an aspect, the present invention provides a task-based video analytics processing system, including an event and data processor, a video analytics task manager, and a shared video analytics resource. The event and data processor initiates a video analytics task in response to generated trigger information and to generate a video analytics task request. The video analytics task manager is in communication with the event and data processor, and receives and manages video analytics task requests, and routes a selected video analytics task to its intended destination. The shared video analytics resource is in communication with the video analytics manager and with at least one video source to obtain video to be analyzed in response to receipt of the selected video analytics task, and to perform requested video analytics on the obtained video.

The event and data processor can include a business rules module to convert the generated trigger information to the video analytics task request based on stored business rules. The shared video analytics resource can include a plurality of shared video analytics resources including a selected shared video analytics resource to which the video analytics task manager routes the selected video analytics task. The event and data processor can include a result surveillance module to associate an analyzed video task result with a pending video processing task.

The system can further include a dedicated video analytics resource in communication with the event and data processor to generate the trigger information on the basis of which the video analytics task request is initiated in response to a result from activity at a real-time video source. The system can further include a business intelligence database to receive analyzed video task results and to generate reports based on stored business rules.

The video analytics task manager can include a scheduling module to schedule received video analytics task requests based on task scheduling data associated with the received video analytics task requests. Similarly, the video analytics task manager can include a prioritizing module to prioritize received video analytics task requests based on task priority data associated with the received video analytics task requests. The video analytics task manager can include a buffering module to buffer a received video analytics task request in response to detection of conditions preventing execution of the associated video analytics task. The video analytics task manager can include a license manager to manage a pool of video analytics licenses shared among the plurality of shared video analytics processing resources on an as-needed basis.

The event and data processor can further include a data mining module to selectively identify events of interest based on stored non-video metadata and to generate corresponding trigger information to request analysis of associated video. The event and data processor can further include an administration module to generate a business rules modification task based on a received modification request in order to be able to detect a missed alert, and to generate a business rules modification validation task to ensure that the modified business rules detect the missed alert and still properly detect all previous alerts.

In another aspect, the present invention provides a method of task-based video analytics processing, including the following steps: initiating a video analytics task request in response to received trigger information; routing the video analytics task request to an associated shared video analytics resource; obtaining video to be analyzed in response to receipt of the video analytics task request; and performing the requested video analytics on the obtained video.

The method can further include generating an analyzed video task result based on performance of the requested video analytics. The received trigger information can include an analyzed video task result or non-video metadata, and can be generated based on stored business rules.

The step of initiating the video analytics task can include generating the video analytics task based on the received trigger information. The step of performing the requested video analytics at the associated shared video analytics resource can be independent of analytics performed at another video analytics resource. The step of performing the requested video analytics on the obtained video can include analyzing the video at a processing speed higher than a real-time processing speed.

The step of routing the video analytics task request to the associated shared video analytics resource can include determining whether conditions exist that prevent the video analytics task request from being executed by the associated video analytics resource.

The method can further include: selectively identifying events of interest based on stored non-video metadata; and generating corresponding trigger information to request analysis of associated video. The method can also further include: generating a business rules modification task based on a received modification request in order to be able to detect a missed alert; and generating a business rules modification validation task to ensure that the modified business rules detect the missed alert and still properly detect all previous alerts.

In a further aspect, the present invention provides a computer-readable medium storing statements and instructions which, when executed, cause a processor to perform a method of task-based video analytics processing according to a method as described above.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 illustrates a task-based video analytics system according to an embodiment of the present invention.

FIG. 2 illustrates a task-based video processing system according to another embodiment of the present invention.

FIG. 3 illustrates exemplary contents of a video analytics task request according to an embodiment of the present invention.

FIG. 4 illustrates exemplary contents of an analyzed video analytics task result according to an embodiment of the present invention.

FIG. 5 illustrates a task-based video processing system according to another embodiment of the present invention, showing details of the video analytics task manager.

FIG. 6 illustrates an exemplary time and processing diagram for a plurality of tasks having different priority properties.

FIG. 7 illustrates an exemplary time and processing diagram for a plurality of tasks having different scheduling properties.

FIG. 8 illustrates an exemplary time and processing diagram for a plurality of tasks using buffering.

FIG. 9 illustrates a task-based video processing system according to a further embodiment of the present invention.

FIG. 10 illustrates an exemplary output of an administration module when reviewing a current set of rules.

FIG. 11 illustrates an exemplary output of an administration module when reviewing a current set of rules and a proposed rule change.

### DETAILED DESCRIPTION

Generally, the present invention provides a system or method for task-based video analytics processing, which can include dynamic allocation and sharing of video analytics resources. This can reduce cost and improve scalability. Video analytics tasks are created in response to trigger information, which can be based on stored business rules, events and/or data of interest. The tasks are forwarded to a video analytics task manager, which manages and distributes tasks to appropriate video analytics resources according to parameters such as scheduling, priority and/or events. Video from the appropriate video source, either a video stream or stored video, is only obtained after the video analytics task is received at the video analytics resource. Video analytics are performed on the video itself, not on video metadata. Data mining of non-video metadata can be used to identify stored video of interest. Configuration tuning can be used to modify a business rule and validate whether the modified rule would affect previous correct data.

The present invention relates to video analytics, resource sharing, dynamic allocation and intelligent video surveillance. While many applications of distributed or shared video analytics relate to security and perimeter-based type protection, they can also be extended to facial recognition, license plate recognition and similar applications.

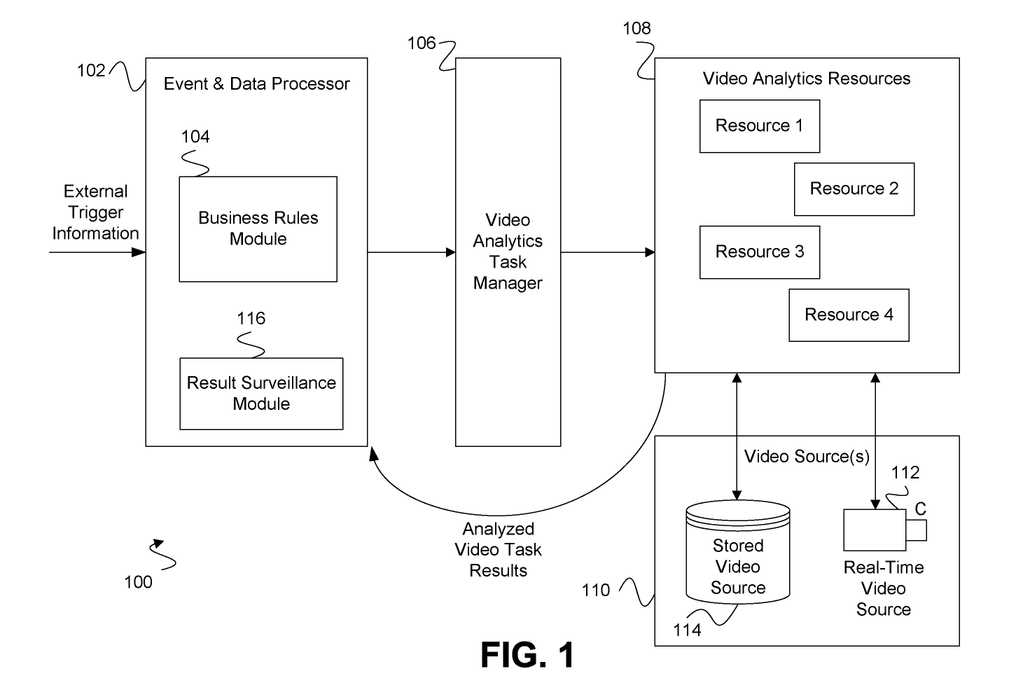

FIG. 1 illustrates a task-based video analytics system 100 according to an embodiment of the present invention. An event and data processor 102, or video analytics task initiator, initiates video analytics tasks in response to received trigger information. The term “trigger” as used herein represents any event, data, alert, result, or other information that initiates a need for video processing, or video analytics. The received trigger information can be internal or external trigger information. External trigger information can be based on external event information, on data such as financial or point-of-sale data, and/or on alerts, such as physical alarms or smoke detector alarms. The external trigger information can be received in real-time or from a database, and can include non-video metadata. Internal trigger information can be generated by a business rules module 104, based on stored business rules or logic.

The business rules module 104 can store business rules, or business logic, such as relating to security of monitored premises. For example, a rule can be to perform data processing at a particular time, or on a recurring schedule. Business rules can be set up to monitor situations relating to different types of business needs. For example, business marketing rules can gather business intelligence type information, and loss prevention information, such as investigating fraud at a teller location. Security rules can be set up to detect breaches at entrances, monitor certain locations at certain times, or establish and monitor virtual trip wires.

Externally received trigger information can optionally be processed by the business logic rules 104 to determine the appropriate video task parameters to be created. While the business rules module 104 is shown internal to the event and data processor 102, it can be placed anywhere in the system as long as it is in communication with the event and data processor. This also applies to other modules, which will be described later.

Initiating a video analytics task can comprise generating the video analytics task or initiating a stored video analytics task. In the case of generation, the video analytics task can be created by the event and data processor 102 based on received trigger information, either internal or external, or both. Alternatively, the event and data processor 102 can initiate a video analytics task from a set of stored tasks based on the business logic rules 104 and/or based on received trigger information. In another embodiment, the received trigger information, whether internal or external, can itself comprise a formulated video analytics task, ready to be forwarded.

Video analytics tasks, or task requests, are sent to a video analytics task manager 106, which manages, routes, and/or distributes the video analytics tasks to the appropriate video analytics resource, which can be one of a plurality of video analytics resources 108. The video analytics resources 108 can be shared between a plurality of video sources 110. Upon receipt of the video analytics task, the selected video processing resource obtains the video to be processed from the appropriate video source 110. The video source can be a real-time video source 112, such as a camera, or a stored video source 114, such as a video archive. In the embodiment of FIG. 1, the shared video analytics resources 108 can perform a number of types of analytics without the need to move through a hierarchy of levels. As such, the resources are not shown in a hierarchical manner, since access to the resources is not restricted in that way.

The video to be processed is only obtained after the video analytics task is received at the video analytics resource 108 being used to perform the analytics. Standard communication protocols can be used for the acquisition and transmission of the video to be analyzed. The video analytics resource then performs video analytics on the video itself, not on video metadata as in known approaches. After the video analytics resource has completed the video analytics task, the resource can send an analyzed video task result back to the event and data processor 102. The received analyzed video task result can be considered a particular type of trigger information that can be received by the event and data processor 102.

Generally speaking, a video analytics system can include devices such as recorders and encoders (not shown). A recorder has the video being stored in the unit itself, whereas an encoder stores the video in a location external to itself. Multiple recorders or encoders can be provided in a system. The video analytics resources 108 can be DSP-based. A video source 110 can be located at the recorders/encoders, from which video can be sent over internet protocol (IP). Analog cameras can be connected to the recorders/encoders. IP cameras can send video through the recorders/encoders, or directly provide IP video to the shared video analytics resources 108. Most existing approaches perform video processing through an analog connection. A DSP-based video processor can have a one-to-one connection to each analog video camera. The video analytics resources output analyzed video task results, which can include metadata, alerts and/or alarms. The analyzed video task results can be output to the system, either to the recorders/encoders, or to a database.

Sometimes, a video analytics task can depend on its corresponding analyzed video task result to determine further action to be taken. In an embodiment, the event and data processor 102 can include a result surveillance module 116 to determine whether received trigger information comprises an analyzed video task result, so that it can be processed accordingly. For example, the result surveillance module can examine the analyzed video task result to determine if it includes an identifier corresponding to a pending video processing task, and can then pass the result to the business logic rules 104 for further processing. It can then be determined whether the current task can be marked as completed, and whether completion of this task should initiate a further video processing task.

Known approaches start with a video stream and perform video processing on the video stream (or a subset/modification thereof) at different times in a pipelined manner. An embodiment of the present invention begins with trigger information, such as from data and/or events.

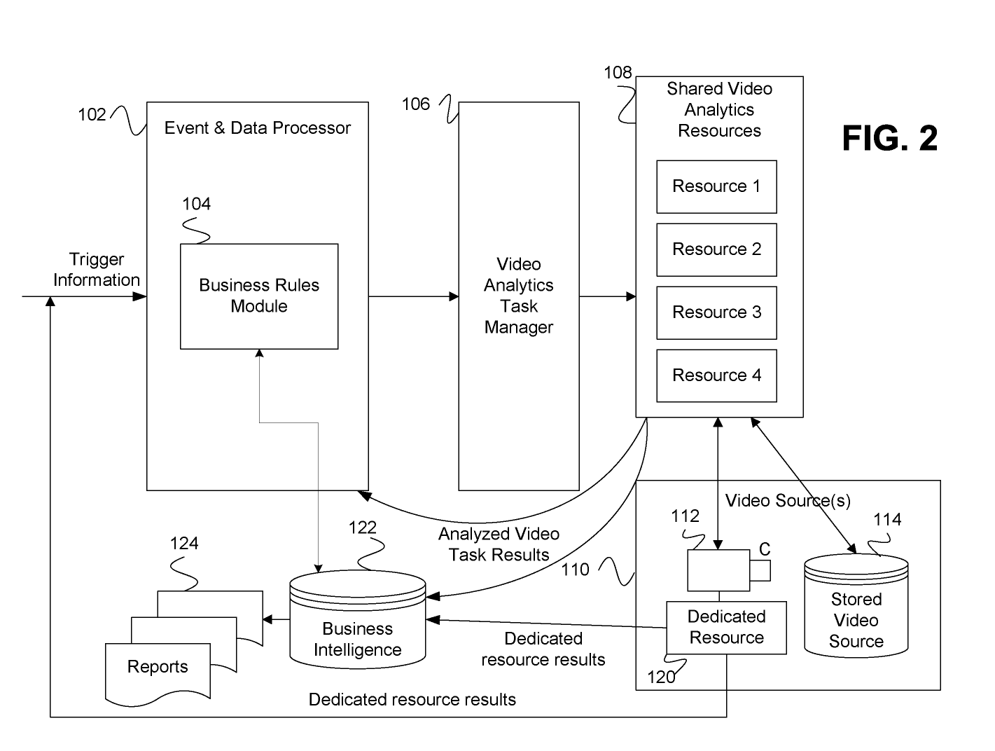

FIG. 2 illustrates a task-based video processing system according to another embodiment of the present invention. The system includes a dedicated video analytics resource 120, or video processing resource, at or in communication with the real-time video source 112. The embodiment of FIG. 2 is a specific case of the more generic approach of FIG. 1 in which a lower level of analytics is performed by a dedicated resource, and higher levels of analytics are performed at shared resources.

A video analytics system or method according to the embodiment of FIG. 2 can include one or more of the following advantageous characteristics:
1) Deploy front end analytics that are inexpensive to operate.
2) Use the front end analytics to flag basic activity so that the channel can be “promoted”/connected to a more complex/expensive analytics process on an as needed basis.
3) Share complex/expensive analytics channels dynamically between multiple video acquisition channels.
4) Use complex/analytics channels to process off-line pre-recorded video during idle periods or off-hours to produce video meta-data or business visual intelligence.

For example, in an indoor environment where there is less motion, a camera with motion detection can be deployed at a bank's ATM. When motion is detected, the camera results, or dedicated resource results, can be provided as trigger information to the event and data processor 102 to generate a video analytics task requesting higher level processing.

This embodiment of the present invention provides different layers of analytics capability, with a basic level at the camera, or close to the camera. Internet Protocol (IP) cameras can perform motion detection with only basic hardware. More advanced analytics require more expensive hardware, such as DSPs, and can also demand that the camera is hard-wired or “nailed down” to the processor. An example of hierarchical levels of analytics can include: car detection, license plate detection, and license plate number recognition. Another example can include: motion detection, person detection/discrimination, face detection and acquisition, and facial recognition.

The “escalation” of a requirement for higher level analytics in response to a result from a lower level of analytics is an example of a video analysis task initiated by business logic, which can be provided in the business rules module 104, or at the dedicated resource 120. Known approaches use an approach of filtering within the pipeline rather than escalating to further processing only when needed, and directly if possible. In known approaches, if video data needs stage 4 processing, it must first go through all of the stages 1-3. According to an embodiment of the present invention, through creation of tasks, a determination is made regarding what processing or analytics needs to be done, and under which parameters, and then it can be done without having to go through a pipeline. Succeeding levels of analytics do not need to be performed on-the-fly according to an embodiment of the present invention, but can be performed at any appropriate time, since video can be stored in a stored video source 114 and retrieved in response to applicable trigger information.

In a particular embodiment, level 1 video analytics can be video motion detection (VMD) where movement is detected, level 2 can be people detection or tracking, and level 3 can be behavioral analysis such as loitering detection or vandalism detection. Alternatively, level 2 could be face detection and level 3 can be facial recognition. Level 1 can be implemented within the camera, otherwise referred to as a local processor. Level 2 can be implemented in a branch processor and level 3 can be implemented in a centralized processor.

In a presently preferred embodiment, processing is performed at the network level. In known approaches, such as those using analog cameras, each camera is hard wired in a particular configuration to certain processing entities. With IP cameras, video streams can be switched much more simply. Embodiments of the present invention are preferably implemented in digital video surveillance systems and particularly those where video is transferred over IP. The camera itself can be a digital video camera, such as an IP camera, or an analog camera coupled to a digital video recorder (DVR) that can encode and packetize the video into IP packets, such as in the MPEG4 format. It is preferable to have the video stream packetized and encoded in a format such as MPEG4, so that it can easily be transmitted over a network, such as a local area network (LAN).

Referring back to FIG. 2, in an embodiment the dedicated resource results and/or the analyzed video task results can be sent to a business intelligence database 122. The business intelligence database 122 can be used to generate reports 124 based on information stored in the business rules module 104. The business intelligence database can also receive information from other non-video sources, and can be a source of financial data, point-of-sale data, or other external trigger information as described earlier. The business rules module 104 and the business intelligence database 122 are in communication with each other, either directly or via an optional intermediate data processing module (not shown) that can process the data from the database.

Transaction data that is collected in retail and banking applications can be provided to the business intelligence database 122. This data can be used to generate trigger information requesting a higher level analytics task. For example, in a retail installation, if a refund is processed, video analytics can be applied to determine who is present at a cash register. Therefore, the generation of a refund can be a trigger to run video analytics to determine if a “refund-no customer” condition is present, where the cashier is detected as the only person in the video during the transaction. Existing methods of detecting the presence of a person, such as in US Patent Application Publication No. 2006/00227862-A1 entitled Method and System for Counting Moving Objects in a Digital Video Stream and published on Oct. 12, 2006.

In banking applications, facial recognition can be used as a higher level analytics. Facial recognition may only be triggered in response to detection of certain types of transactions. For example, if someone accesses a particular account, facial recognition can be used to determine whether the person accessing the account is authorized to do so. It can also be used if an incorrect account password is entered a certain number of times.

As another example, in retail applications a transaction log is typically generated once per day after a store closes. The business rules module 104 (or a data mining module provided therein) can be used to identify every refund transaction in the log, and use that as a trigger to acquire the video of that refund, run it through the video analytics, and determine whether a customer was present. This is a combination of off-line video processing and external triggers to selectively choose portions of video to process. Depending on the type of alert, the business rules can include data enabling automatic identification of the type of analytics required.

Generally, all of these applications are enabled by the same fundamental mechanism of having tasks generated and distributed, as needed, to shared video processing resources on the network. Software and/or hardware is provided to use those resources in a flexible way to line up particular video streams for processing. The video can be live or stored/archived. The resources are dynamically allocated.

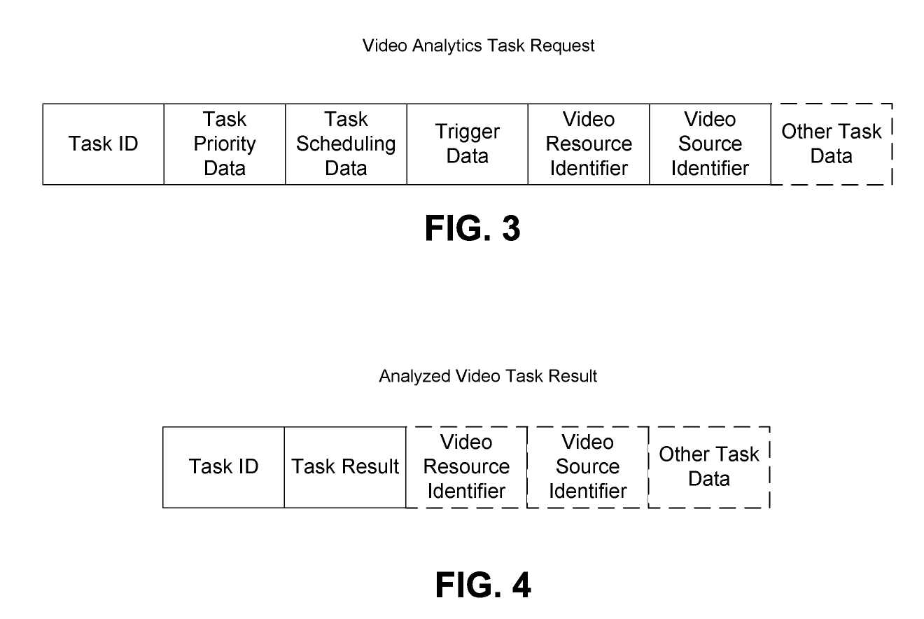

FIG. 3 illustrates exemplary contents of a video analytics task request according to an embodiment of the present invention. Logic to interpret and process the contents of the request can be provided in the task manager 106. The request can be a packet or any other type of data transmission unit. FIG. 3 shows that the task request can include a task identifier, task priority data, task scheduling data, trigger data, a video resource identifier, a video source identifier, and optionally include other task data.

The task identifier, or task ID, can identify the task either as being a unique instance of a task (i.e. a universally unique identifier), or as being a particular type or class of task (e.g. a high level security task, or a low level maintenance task). The task ID can be used by the result surveillance module 116 in FIG. 1 to associate a result with the corresponding request. Alternatively, in the absence of a task ID, the remaining data in the request can be used to uniquely identify the task request or request type. The request can include task priority data to indicate a relative priority of the analytics task. The task scheduling data can indicate scheduling information for the task, such as if it must be run at a certain time or within a certain time window, or after completion of another task.

In an embodiment, task priority data and/or task scheduling data can be derived based on the task ID or other information in the task request. For example, a task request having a task ID associated with a security breach can implicitly have high priority and immediate scheduling parameters, which can be derived by the video analytics task manager upon identification of the task.

The trigger data can be provided in the task request to indicate information regarding the event or data that triggered the task request. The trigger data can be considered as a generic task identifier when it identifies a particular event, or type of event. The video resource identifier can indicate one or more resources that are able and/or available to perform the requested task. The video source identifier indicates from where the video resource is to obtain the video. Other task data can optionally be included to further specify information relating to the video analytics task request. The task request does not include the video to be analyzed, nor is it transmitted to the video analytics resource with the video. It is sent to the video analytics resource, so that the resource can then acquire the video to be analyzed.

FIG. 4 illustrates exemplary contents an analyzed video analytics task result request according to an embodiment of the present invention. In an embodiment, the analyzed video task result can include a task ID and a task result. The task ID can have similar properties as discussed in relation to FIG. 3. The task result can indicate whether the task has been successfully completed, or terminated without success, or whether a further analytics task is to be performed based on a particular result. Optionally, the analyzed video task result can include the video resource identifier, the video source identifier, or any other task data that can be used to process the result and generate corresponding business data or further analytics tasks.

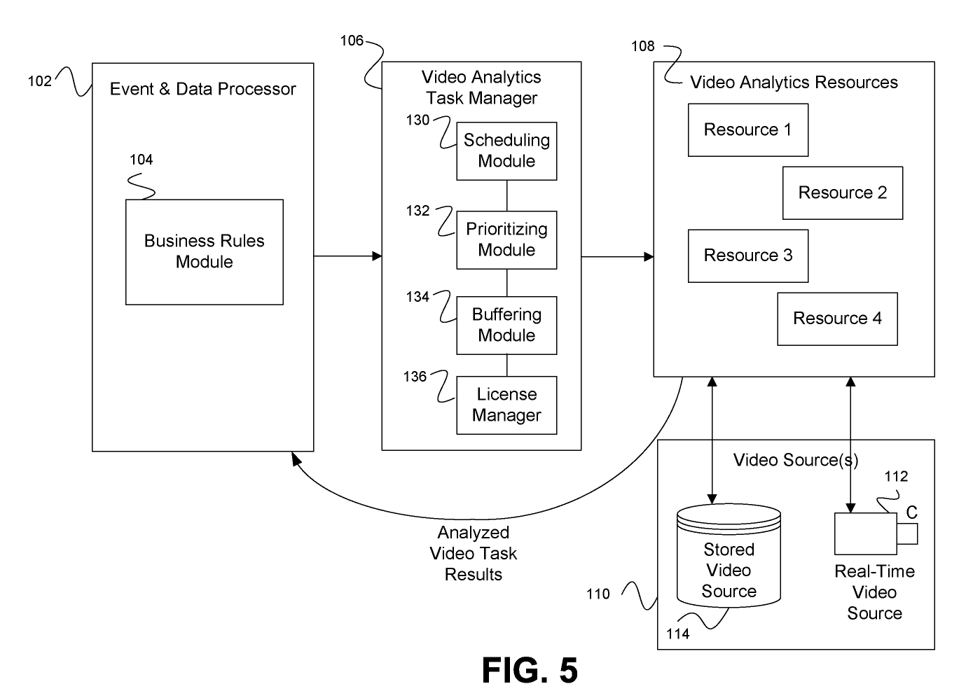

FIG. 5 illustrates a task-based video processing system according to another embodiment of the present invention, showing details of the video analytics task manager 106. In this embodiment, the video analytics task manager 106 includes a scheduling module 130, a prioritizing module 132 and a buffering module 134. While these modules are discussed separately below, in an embodiment one or more of these modules can be integral with one another. The modules can also be in communication with one another, either directly or indirectly, to determine the appropriate task processing based on information from the other modules, or on externally received information, such as trigger information.

The scheduling module 130 schedules the received video analytics task requests based on task scheduling data associated with the task request. Similarly, the prioritizing module 132 prioritizes the received video analytics task requests based on task priority data associated with the task request. As mentioned earlier, the priority and/or scheduling data on which the task manager processes the requests can be explicitly included in the task request, or can be derived from the task request based on the task ID or any other suitable combination of identifying data.

The buffering module 134 buffers video task requests when scheduling, priority, availability and/or other conditions prevent the video task request from being delivered to the appropriate video analytics resource. For example, if the video analytics resource is in use, or a higher priority task is received, a task request can be queued in the buffer until the appropriate resources are available. The buffering module 134 can be provided as a shared buffer for all of the resources. Alternatively, separate dedicated buffers can be provided for each video analytics resource, depending on known processing needs or demands. In another embodiment, the buffering module having a shared buffer can include logic to dynamically change the size of buffers assigned to certain video analytics resources based on received trigger information, such as analyzed video task results, video metadata or non-video metadata.

In known approaches, each camera in a video surveillance system has a particular license that is associated with the camera, and that license enables the camera to perform specific functions. According to embodiments of the present invention, channels can be assigned dynamically. There is also the ability to change channels on a scheduled basis. For example, if a system has eight cameras, the scheduling module 130 can direct a first camera on a first schedule to run a first analytic, and on a second schedule the video stream is redirected from an analytics processor to a different input. Therefore, in a network of cameras, analytics can be shared among a plurality of cameras such that the analytics are performed for a short period of time, such as 10 minutes, on the plurality of cameras in succession, or in some other time sharing pattern.

In the realm of software licensing, it is possible to have a pool of licenses to access a particular program. If a user logs in and asks to use that program, the user employs the license until termination of use the program, at which time the license is returned to the pool for use by another user. That scenario can be described as the reverse concept of what can be accomplished according to another embodiment of the present invention. Rather than moving video around a network to have different layers of analytics processing be performed at different locations, a video analytics license manager 136 can manage the sharing, distribution and management of analytics licenses on an as-needed basis, to permit the performance of different types of analytics at the same location, assuming that the necessary software and hardware are present.

A video analytics license pool, or video processing license pool, can be implemented by the license manager 136. For example, according to this approach, if a camera is not currently running perimeter protection or loitering detection, that license can be shared with another camera on the same network. A similar concept can be applied to a video encoder running H.264; when the camera is not detecting any motion and therefore not streaming any video, the camera or end-point still has the encoding license. While the video analytics license manager 136 provides central distribution, revocation and management of the licenses, the manager itself can be physically or logically provided in a central or distributed manner.

In general, in such an embodiment, algorithms for different types of analytics can be stored locally at a camera or end-point. If a particular analytic is not currently being run at the camera, the license associated with the analytic not currently being used is sent to a pool for use by other cameras. Therefore, a license can be sent to the pool upon detection that it has not been used for a given length of time, which can vary depending on the type of license.

In a network spread over multiple time zones, analytics can be performed on channels associated with cameras in each time zone at a time of day when activity is generally known to occur. When activity is generally not observed in a time zone, the analytics will be performed on a channel in another time zone in which activity is likely.

These embodiments lend themselves well to an IP deployment, and to a distributed localized and centralized processing of a video signal. Embodiments of the present invention provide resource sharing in digital video surveillance, which permits sharing of channels. A video switching fabric can be provided to implement such a solution.

If a priority type 2 video task request is received and a slot is not available, but a slot is available at a later time, the system can prioritize the video streams and begin streaming what has been recorded. In the case of security alarms, a priority 2 may be a possible security breach rather than a significant security breach. In that case, the system can still process the alarm and generate an alert without performing all of the processing immediately, knowing of its lower priority. The scheduling and prioritization scheme can be implemented in a number of different ways depending on business requirements, but the underlying fundamentals are the same.

Real-time needs are usually security-based, such as detection of an event, e.g. whether someone is breaking in to monitored premises. Processing power in the video analytics can be off-loaded, either on a time basis or on the basis of detection of whether resources are being used. Non-real-time needs include those relating to operational, marketing, or service analysis or applications. Examples of these implementations include: people counting, such as at entries and exits; determining how well in-store advertising is working by examining at the end of a full day of video how long each customer stood in front of a sign; determining shopper “traffic” patterns (whether they go left or right in a particular aisle); and generating “heat maps” showing traffic density in two different aisles or at two different points in a retail establishment.

When the real-time video is either idle or in off-peak hours, the resource can be shared and used to perform analytics on stored video, such as archived an non-real-time video. For example, the shared video resources can be used from 8 am-5 pm for gathering and processing real-time video, such as detecting events and performing security-related functions. From 5 pm-6 am, the shared video resources can be used to run the stored video through analytics in order to obtain business data, such as marketing data. This business data is typically stored in a database, from which various reports can be generated, as shown in FIG. 2.

In another example, a company that has many store locations may want to process the video centrally and off-line to obtain business intelligence data. Time sharing of resources allows the company to process video for peak hours (e.g. 4 hours from 10 am-2 pm and 3 pm-5 pm) for a plurality (e.g. 6) of cameras over the space of 24 hours.

This embodiment mixes the types of video used as an input for the smart processing of video, or video analytics using shared video resources, and deals with sharing of resources or licenses for video processing. The fact that video analytics are performed at shared resources, such as on a LAN, provides flexibility. A plurality of video analytics processing tasks (T1, T2, T3) can be shared over time, and each one assigned different priorities.

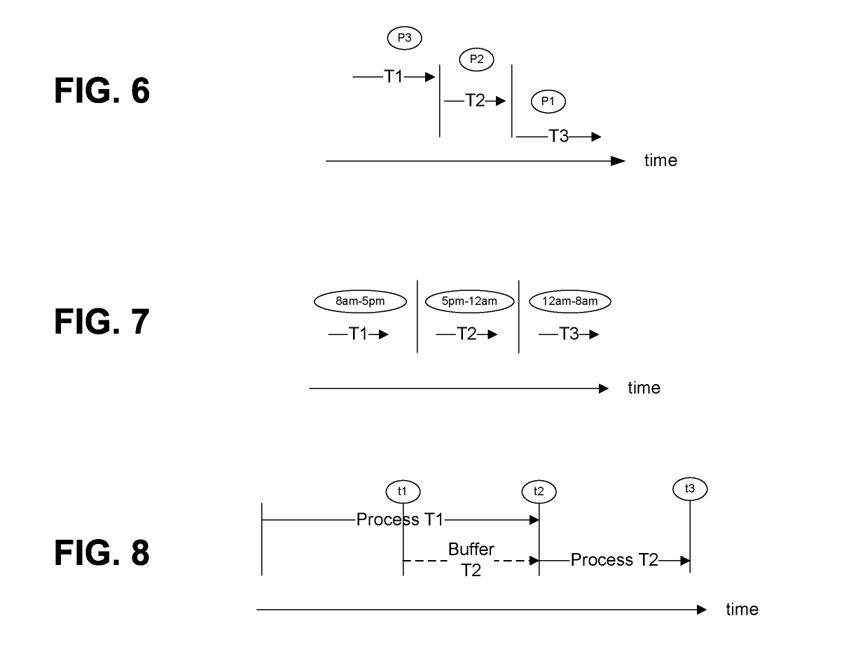

FIG. 6 illustrates an exemplary time and processing diagram for a plurality of tasks having different priority properties. In FIG. 6, video analytics task T1 has a priority of P3, but is received first. Video analytics task T2 is then received with a priority of P2. Since it has a higher priority, it can “bump” the processing, or distribution, of task T1. Similarly, when task T3 is received with priority P1, the prioritizing module determines that this task has higher priority, and arranges for it to be completed accordingly. Once the video streams are received in the shared video processing resources, they can be processed in priority order, rather than in the order in which they are received. Alternatively, the task manager can perform the prioritization. As a result, the prioritizing module can be provided in the task manager or in the video processing resource(s).

FIG. 7 illustrates an exemplary time and processing diagram for a plurality of tasks having different scheduling properties. In this example, analytics tasks from three different locations can be scheduled to be processed during particular time intervals. As such, the resources can be used more efficiently. In the case where scheduling data is absolute scheduling data, i.e. it must be performed at a given time or in a defined time window, this scheduling data can be interpreted as, or converted to, priority data by the task manager.

FIG. 8 illustrates an exemplary time and processing diagram for a plurality of tasks using buffering. Typically, tasks will include a combination of scheduling and priority data. This can result in contention for a video processing resource, as can the unavailability of the required video processing resource. Since the video itself is not sent with the video analytics task request, it is easier to buffer the task, as opposed to buffering the task request and the video as in known real-time pipelined systems. As shown in FIG. 8, a process T1 is shown as pending, or being completed at time t1. The pending or in-progress status of the task can refer to whether it has been sent out to the video analytics resource for processing. Alternatively, the status of the task can refer to whether the analytics are being performed. In that case, the analytics can be paused if they are not as important with respect to priority or scheduling as a task T2 received at time t1. In the case where the task T1 cannot be paused because of task T2, the task T2 can be buffered until the completion of task T1 at time t2, or until the required video processing resource is available. This can result in near real-time processing even when buffering is required. The buffer time can be, for example, in the range of about 2 seconds to about 10 seconds.

For example, suppose the video processing resource is processing video on channel 1, but then that processing is de-prioritized in favor of another stream that is being escalated. The video processing resource can have different buffers, so that the processing is almost real-time. The buffering occurs before the processing. As such, video streaming can begin before the resources are actually available. In an embodiment, they always store the video stream being received. The video stream can include a trigger requiring certain resources, but the resources may not be available until a later point in time. The buffering can be in response to that trigger that a certain resource is required before it is available.

This flexibility enables the system to prioritize video streams. In some cases, it can take about 5-10 seconds to get a video stream to a processor by task switching. The buffering mechanism also enables the system to process archived video.

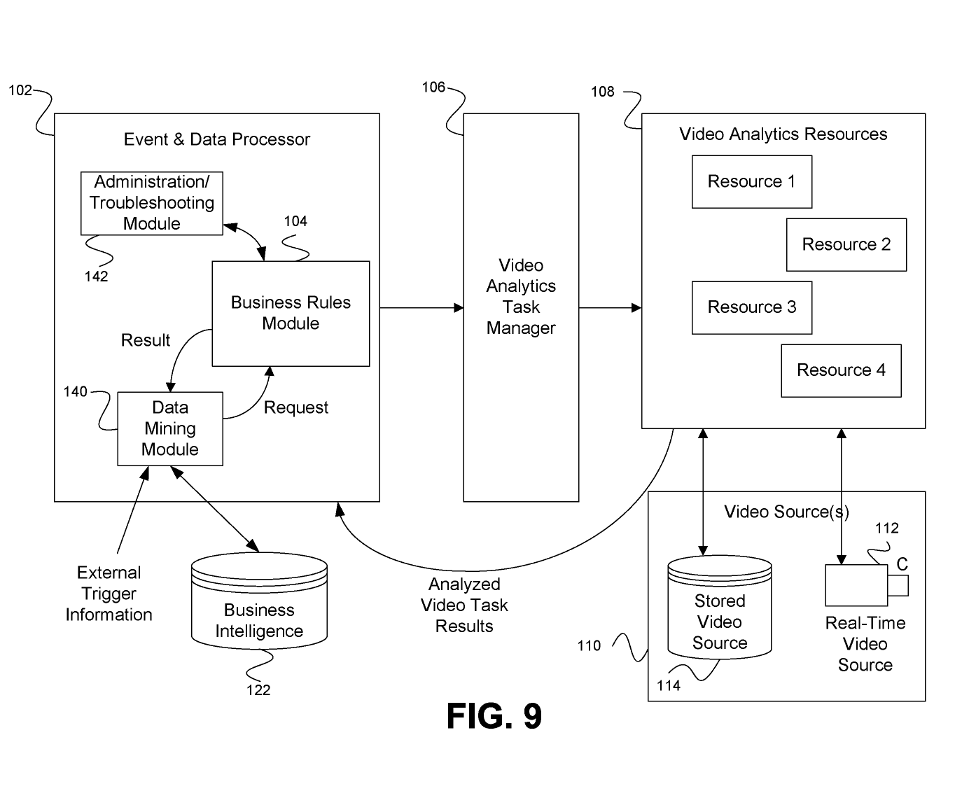

FIG. 9 illustrates a task-based video processing system according to a further embodiment of the present invention, with additional modules within the event and data processor 102. A data mining module 140 is provided to identify an event of interest. The data mining module 140 can mine data from the business intelligence database 122, or any other database. It can alternatively, or in addition, receive data in the form of external trigger information. An example of a data mining situation will now be described. At a point-of-sale, daily or monthly queries can be run to identify certain transactions that warrant investigation, based on an identification of suspicious patterns, etc. A data mining method can identify the event, obtain the video, run the video through video analytics, and determine if there is additional information that continues to makes the event of interest a suspicious event (e.g. no manager present).

With known approaches, metadata of every transaction must be processed, since the video is received in real-time. For example, a camera is pointed at every cash register, all the time. When there is a refund, a database search is then done through the primitives to see if there is a customer present.

According to an embodiment of the present invention, data mining is performed to filter out the number of events/transactions based on non-video metadata, and then video content analysis is performed based on the filtered post-processing of the data mining results. As a result, a method or system according to an embodiment of the present invention selectively identifies video that needs to be processed based on associated non-video metadata that is mined based on business logic, etc.

Known pipelined computing architectures with buffers perform hierarchical processing, and the data mining criteria come from analysis of the video. In contrast, according to an embodiment of the present invention, a business rules (or business logic) based architecture is provided that shares video processing resources, and distributes video processing resources to better utilize them. Distributed processing is shared based on the logic rules. Additional criteria can be applied. In known approaches, video is always processed as it comes in. According to an embodiment of the present invention, video is only processed when business logic indicates it is desired, by creating a video analytics task.

Data mining of non-video metadata can create a new video processing task. The data mining module 140 can create trigger information to request analysis of video that has not been processed before. In known systems, data mining occurs in a video processing pipeline after some initial processing. According to an embodiment of the present invention, data mining occurs before the video is processed. The data mining can generate video processing tasks on its own, or a request to create such a task.

The embodiment of FIG. 9 also illustrates an administration/troubleshooting module 142. The administration module, or troubleshooting module, 142 can be used for configuration tuning when changing or adding a business rule. Moreover, it can be used to verify or validate proposed changes.

According to known systems, live video is fed into video analytics. The video analytics runs rules. As those rules are triggered, events are detected and metadata can be generated. Sometimes the rules can be set up incorrectly such that an event that should be detected is not properly detected, or false alarms are generated.

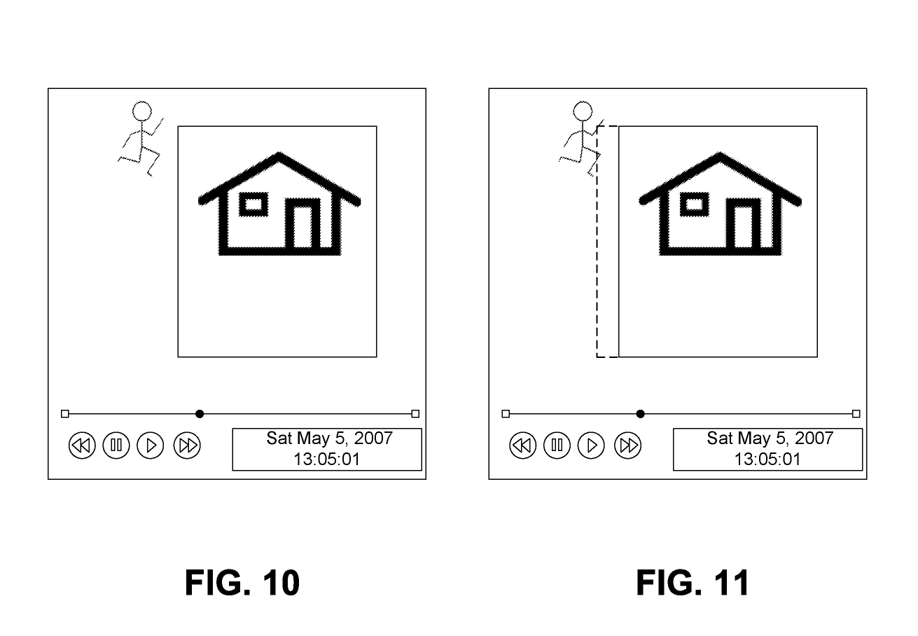

In order to overcome this drawback, a system as illustrated in FIG. 9 is provided. As the video is run through the system, it can also be archived and stored, preferably substantially simultaneously. The stored video can then be automatically run through the same rules to provide an interactive view of the analytics, which will be described in further detail in relation to FIGS. 10 and 11. This functionality can be provided by an analytics viewer (not shown) provided as part of the administration/troubleshooting moduel 142.

This interactive analytics view displays the video as well as the mark-up and the rules, preferably superimposed on the video. The video can then be examined to determine why an event that should have been detected was not detected. For example, a person could have been too small to be detected by the person detection algorithm, or a truck may have been missed by a car detection algorithm due to a size filter that was optimized to detect cars.

The rules can then be modified, and the same stored video can be re-run through the video analytics with the modified rules to determine whether the modification was sufficient to overcome the detection problem. For example, the system determines if the change will result in either missing an event that should have been detected, or in erroneously indicating detection of an event that should not have been detected. This permits easy optimization of video analytics rules from within the product, without involving third party processing.

Embodiments of the present invention can also provide a way to review stored video in accordance with non-video metadata to determine the cause of a false alarm, or why an alarm was not issued when it should have. Using the administration module 142, a user can review rules that were active at the time in conjunction with the video and associated metadata to determine the cause of the missed or false alarm, and to determine what change to the rules would have resulted in a proper response. The rules can be reprogrammed based on the determined desired changes.

In known approaches, a third party reviews the video offsite and recommends a change, or delta, for the relevant programmed rules. A change is then made to the program and the user must typically wait until subsequent occurrences of a false alert, or missed alert, before determining if the recommended change results in the desired response. According to embodiments of the present invention, the stored video is taken as an administration task: the archived video is run through analytics based on existing rules and see results on the recorded video. The programming can then be changed, and the same archived video can be re-run through the video analytics based on the changed rules, to verify the programming changes. By bringing back the exact conditions that cause the false alert or missed alert, embodiments of the present invention can assist in determining with certainty whether a recommended change will solve a problem. The change, or modification, can also be a new rule, or new programming, that did not exist before.

The administration module 142 is preferably provided as part of a video recording device that includes video recording and video analytics capabilities. The product then inherently has an administration/troubleshooting capability, without having to employ third-party analytics external to the device. Embodiments of the present invention advantageously incorporate troubleshooting, the ability to bring in recorded video, change rules and re-run the video automatically, as part of the product. This has typically been done in known systems by manually extracting the video and running video analytics offsite. An offsite person then recommends a change (or a new rule), then a user at the video recorder implements the change and hopes it works.

According to an embodiment of the present invention, based on a trigger in non-video metadata, the system can load stored video corresponding to the trigger event and determine whether existing or modified rules will result in a proper response. In an embodiment, troubleshooting can be included as a scheduled task. Alternatively, the system can provide the ability to schedule a task to troubleshoot.

Using known products, if a user wants to perform troubleshooting on-site, the analytics for a particular channel must be turned off. In embodiments of the present invention, troubleshooting it provided as a task (which may be lower priority) and can be performed when there is a free resource, without affecting other video processing abilities or tasks. A troubleshooting task, or reconfigure task, can be provided as a particular type of video processing, or video analytics, task.

With respect to scheduling, suppose over a period of a few months, six valid alarms were issued and one false alert was issued. By changing a rule something to remove the false alert, it is possible that the system has been changed such that a valid alert would be missed. An advantage of an embodiment of the present invention including an administration module 142 is that after a programming change, the system can automatically re-validate valid alerts to make sure that a change does not adversely affect previous proper results. This becomes a task of submitting a programming change for video analytics to address a false alert, then performing a validating (or re-validating) task to make sure you are not filtering out any valid alerts.

Similarly, administrative programs can create new video processing tasks. The video processing task can be one to view false alerts, confirm programming of new rules, confirm reprogramming or modification of existing rules, confirm or revalidate previous alerts based on new/modified rules.

FIG. 10 illustrates an exemplary interactive analytics view generated by an administration module when reviewing a current set of rules. The view shows a house under surveillance, with a set of virtual tripwires to detect whether an intruder has crossed a defined boundary. FIG. 10 shows that a potential intruder was relatively close to the house at a particular time, but would not have been detected as crossing the tripwire lines. FIG. 11 illustrates an exemplary output of an administration module when reviewing a current set of rules and a proposed rule change. In FIG. 11, a new proposed tripwire position is shown in dashed lines. By running the same video through the system using video analytics tasks generated by the administration module, a user is able to verify that this change will, in fact, detect a person at this particular location as an intruder.

FIGS. 10 and 11 also show that the video can be paused, played, viewed in fast rewind or fast-forward. Currently, when streaming mostly real-time video to analytic devices, real-time video can only be processed in real-time. Consequently, 1 hour of real-time video takes 1 hour to process. According to embodiments of the present invention, real-time data can be stored for subsequent processing, depending on the type of processing desired.

If the real-time data is stored at a given rate, the data can be processed at a higher rate (in fast-forward) in order to achieve efficiency and time saving. For example, archived data which was stored at 10 frames/second can be processed at a processing speed of 30 frames/second to achieve an efficiency of 3 times. A system according to an embodiment of the present invention can advantageously process video in fast-forward mode for the purposes of more efficient video analytics.

Another application where embodiments of the present invention can be employed is in hosted video surveillance, where video is brought in from many different stores/locations with connectivity back to a service provider. Motion detection can be performed, or the video can be brought over to a central location for processing, either based on events or on a scheduled basis.

Currently, a company can outsource video surveillance, but that just means putting video recorders on-site. In terms of video analytics, this is typically not currently outsourced due to the fact that existing systems do analytics in real-time. People who use video analytics right now include: security people, to detect security breaches or particular conditions; marketing people, for business intelligence type information; loss prevention people, who are looking at fraud at the teller location.

Banks can use embodiments of the present invention to ensure that the “two man rule” in vaults is being observed. For the bank, vault access schedules can be made, and the video does not need to be processed right away. Over time, the video can be processed and a bank is able identify across all branches all of the instances where there was only one person in the vault. For example, the determination can be done based on motion: if no motion is detected (i.e. there is no one there), the system does not process the video. In response to detection of motion, the processing of these events can be done in real-time or off-line.

In the above description, for purposes of explanation, numerous details are set forth in order to provide a thorough understanding of the present invention. However, it will be apparent to one skilled in the art that these specific details are not required in order to practice the present invention. In other instances, well-known electrical structures and circuits are shown in block diagram form in order not to obscure the present invention. For example, specific details are not provided as to whether the embodiments of the invention described herein are implemented as a software routine, hardware circuit, firmware, or a combination thereof.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium, including magnetic, optical, or electrical storage medium including a diskette, compact disk read only memory (CD-ROM), memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine readable medium may interface with circuitry to perform the described tasks.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A task-based video analytics processing system, comprising:
an event and data processor to initiate a video analytics task in response to generated trigger information and to generate a video analytics task request;
a video analytics task manager, in communication with the event and data processor, to receive and manage video analytics task requests and to route a selected video analytics task to its intended destination; and
a shared video analytics resource in communication with the video analytics manager and with at least one video source to obtain video to be analyzed in response to receipt of the selected video analytics task, and to perform requested video analytics on the obtained video.

2. The system of claim 1 wherein the event and data processor comprises a business rules module to convert the generated trigger information to the video analytics task request based on stored business rules.

3. The system of claim 1 wherein the shared video analytics resource comprises a plurality of shared video analytics resources including a selected shared video analytics resource to which the video analytics task manager routes the selected video analytics task.

4. The system of claim 1 wherein the event and data processor comprises a result surveillance module to associate an analyzed video task result with a pending video processing task.

5. The system of claim 1 further comprising a dedicated video analytics resource in communication with the event and data processor to generate the trigger information on the basis of which the video analytics task request is initiated in response to a result from activity at a real-time video source.

6. The system of claim 1 further comprising a business intelligence database to receive analyzed video task results and to generate reports based on stored business rules.

7. The system of claim 1 wherein the video analytics task manager comprises a scheduling module to schedule received video analytics task requests based on task scheduling data associated with the received video analytics task requests.

8. The system of claim 1 wherein the video analytics task manager comprises a prioritizing module to prioritize received video analytics task requests based on task priority data associated with the received video analytics task requests.

9. The system of claim 1 wherein the video analytics task manager comprises a buffering module to buffer a received video analytics task request in response to detection of conditions preventing execution of the associated video analytics task.

10. The system of claim 3 wherein the video analytics task manager comprises a license manager to manage a pool of video analytics licenses shared among the plurality of shared video analytics processing resources on an as-needed basis.

11. The system of claim 1 wherein the event and data processor further comprises a data mining module to selectively identify events of interest based on stored non-video metadata and to generate corresponding trigger information to request analysis of associated video.

12. The system of claim 1 wherein the event and data processor further comprises an administration module to generate a business rules modification task based on a received modification request in order to be able to detect a missed alert, and to generate a business rules modification validation task to ensure that the modified business rules detect the missed alert and still properly detect all previous alerts.

13. A method of task-based video analytics processing, comprising:
initiating a video analytics task request in response to received trigger information;
routing the video analytics task request to an associated shared video analytics resource;
obtaining video to be analyzed in response to receipt of the video analytics task request; and
performing the requested video analytics on the obtained video.

14. The method of claim 13 further comprising generating an analyzed video task result based on performance of the requested video analytics.

15. The method of claim 13 wherein the received trigger information comprises an analyzed video task result.

16. The method of claim 13 wherein the received trigger information comprises non-video metadata.

17. The method of claim 13 wherein the received trigger information is generated based on stored business rules.

18. The method of claim 13 wherein initiating the video analytics task comprises generating the video analytics task based on the received trigger information.

19. The method of claim 13 wherein performing the requested video analytics at the associated shared video analytics resource is independent of analytics performed at another video analytics resource.

20. The method of claim 13 wherein performing the requested video analytics on the obtained video comprises analyzing the video at a processing speed higher than a real-time processing speed.

21. The method of claim 13 wherein routing the video analytics task request to the associated shared video analytics resource includes determining whether conditions exist that prevent the video analytics task request from being executed by the associated video analytics resource.

22. The method of claim 13 further comprising:
selectively identifying events of interest based on stored non-video metadata; and
generating corresponding trigger information to request analysis of associated video.

23. The method of claim 13 further comprising:
generating a business rules modification task based on a received modification request in order to be able to detect a missed alert; and
generating a business rules modification validation task to ensure that the modified business rules detect the missed alert and still properly detect all previous alerts.

24. A computer-readable medium storing statements and instructions which, when executed, cause a processor to perform a method of task-based video analytics processing according to claim 13.
